(19) United States
(12) Patent Application Publication
(10) Pub. No.: US 2026/0240111 A1
(43) Pub. Date: Aug. 20, 2026

(54) A SYSTEM FOR IDENTIFYING AN ANIMAL, A METHOD FOR ASSEMBLING A MALE PART AND A FEMALE PART OF SUCH A SYSTEM, AND A CORRESPONDING FEMALE PART

(71) Applicant: ALLFLEX EUROPE SAS, Rahway, NJ (US)

(72) Inventors: Nicolas Sylvie Jean-Christophe CHAMPOMIER, Chateaugiron (FR); Johan Margriet Ernest DECALUWE, Laval (FR); Bruno Philippe Jean TEYCHENE, Mouzleys-Teult (FR); Johan Robert Simon DE MEULEMEESTER, De Pinte (BE); Emiliano ROSSI, Albese con Cassano (IT)

(73) Assignee: ALLFLEX EUROPE SAS, Rahway, NJ (US)

(21) Appl. No.: 19/161,432

(22) PCT Filed: Mar. 1, 2024
(86) PCT No.: PCT/EP2024/055342

§ 371 Date: Sep. 2, 2025

(30) Foreign Application Priority Data
Mar. 3, 2023 (EP) 23305288.5

(51) Int. Cl. A01K 11/00

(52) U.S. Cl. CPC A01K 11/003

(57) ABSTRACT

The disclosure relates to a system for identifying an animal comprising a male part and a female part with an open head having a through-channel. According to the disclosure, the open head of the female part comprises first retention means located at a first end of the through-channel, the first retention means being configured to prevent removal of a tip of the male part through the first end of the through-channel after the male and female parts have been joined. In addition, the open head of the female part also comprises second retention means, located within the through-channel, said second retention means being configured to prevent removal of the tip of the male part through the second end of the through-channel after the male and female parts have been joined.

A system for identifying an animal, a method for assembling a male part and a female part of such a system, and a corresponding female part.

### 1. FIELD OF THE DISCLOSURE

The field of the disclosure relates to systems and methods for marking of animals and/or removing tissue samples from animals. For example, the disclosure relates to tissue sampling tags that can be used to withdraw a sample of tissue from an animal.

More specifically, as described more fully herein, the disclosure pertains to a system for identifying animals enabling a visual and/or electronic tag to be placed on any animal species and possibly enabling a corresponding sample of tissue to be collected.

Such a collecting of tissue, which can be done simultaneously with the placing of the tag, or on its own, makes it possible to preserve cells/tissues carrying the biological and/or biochemical characteristics of the animal, for example to subsequently identify the animal or detect diseases in the animal.

### 2. BACKGROUND

In order for example to improve the tracking of livestock, improve productivity (by eliminating diseased animals or by searching for special genetic characteristics for example), or guarantee the origin of the animals intended for consumption (for example by detecting diseases), it is becoming ever more frequent to collect tissue samples from the animals.

Such collecting of tissues can be done when applying a tag to an animal (at birth for example) using a tissue sampling tag or later using a tissue sampling unit for example. Other tissue-collecting operations can also be carried out throughout the animal's existence, for example to detect diseases and certify the animal's identity by comparison of DNA sequences or to assess its genetic value. Once collected, the sample of animal tissue can therefore be stored and/or transmitted to a laboratory for analysis.

For example, the technique described in patent application WO2014124863 by Allflex Europe can be used to collect a sample of animal tissue simultaneously with the placing of a tag.

According to the technique described in WO2014124863, a system for identifying an animal comprises a male part, a female part, and a detachable device for storing the sample. The male part comprises a stem ending in a tip. The female part comprises a head defining a cavity into which the tip of the male part can be inserted, after passing through the ear of the animal for example, to lock the tag to the animal's ear.

The male part cooperates with at least one cutting element that is intended to cut out a sample of animal tissue. The head of the female part, in the initial state, is opened. Such open head comprises a through-channel, namely a channel open from one end to the other. The open head can thus receive the tip of the male part, introduced in a first end of the channel, and hold a storage device, which can be temporarily or removably fixed to the second end of the channel.

The system also comprises means for closing the open head of the female part, capable of taking at least two positions: an open position enabling the passage of the sample through the channel during a collecting operation and a closed position enabling the channel to be closed in the vicinity of the end at which the storage device was fixed, after the collecting operation. The female part therefore comprises an open head before sample collection, and a closed head after sample collection. The head of the female part is thus not permanently open.

Such a technique offers advantages since it enables the collection of animal tissue simultaneously with the application of the tag, but also has drawbacks.

For example, the means for closing the open head can be difficult to manufacture. They may require several potentially complicated elements, which must move to allow the channel to be held in an open-state during sample collection and to close the channel after sample collection.

In addition, for some applications, it may be desirable to keep the head of the female part open, even after a sample has been collected.

A female part with a permanent open-head (i.e. a head that remains open after the male part has been inserted into the female part) is also known from the prior art. However, such open head is not resistant to fraud. Indeed, as the head of the female part remains open, the tip of the male part can be cut and removed from the female part. The female part can thus be re-used, for example on another animal. If the female part carries an identifier, a same identifier may, as a consequence, be used to identify two different animals, which is problematic and, in some cases, forbidden.

There is therefore a need for a new system for applying a tag to an animal which is tamperproof.

### 3. SUMMARY OF THE INVENTION

The disclosure relates to a system for identifying an animal comprising:
a male part,
a female part with an open head having a through-channel, wherein the head of the female part comprises first retention means located at a first end of the through-channel,
   the first retention means being configured to prevent removal of a tip of the male part through the first end of the through-channel after the male and female parts have been joined.

According to the disclosure, the head of the female part also comprises second retention means, located within the through-channel, said second retention means being configured to prevent removal of the tip of the male part through the second end of the through-channel after the male and female parts have been joined.

According to the disclosure, the head of the female part is permanently open, i.e. is open before and after the male and female parts are joined. In other words, the system according to the disclosure does not comprise means for closing or blocking the open head of the female part.

The open female head disclosed herein has a number of advantages. For example, a user can visually check whether the male part is properly inserted into the female part. The open female head can also allow better venting of the wound that is created in the animal by application of the tag and/or taking of tissue sample. The wound generated by the tip of the male part or a cutting element can thus also heal better with, for example, reduced risk of infection and shorter healing time.

Moreover, thanks to the first retention means located at a first end of the through-channel and the second retention means located within the through-channel, withdrawal of the tip of the male part through the first end or through the second end of the through-channel is prevented after the male and female parts have been joined. More specifically, the tip of the male part cannot be pulled out of the female part thanks to the first retention means. And the tip of the male part cannot be pushed out of the female part thanks to the second retention means. If there is an attempt to remove the tag by pushing or pulling the tip of the male part out of the female part, eventually after having cut or broken the stem of the male part, the tip will remain inside the female head, between the first and second retention means. As the tip of the male part remains within the female part, neither the male part, nor the female part can therefore be re-used to be applied to another animal. The inviolability of the tag or resistance to fraud is thus reinforced, even if the tip of the male part remains visible after the male and female parts have been fitted together due to the open head.

The first retention means comprises, for example, a washer having at least one spring leaf or claw. It is for example a “Starlock” (registered mark) type of stop washer, made of steel, plastic, etc.

The second retention means takes, for example, the form of a toe, a rib, a narrowing of the through-channel, and so on.

According to at least one embodiment, at least one of said first and second retention means is made of:
acrylonitrile butadiene styrene, or
polyamide, or
styrene (for example PS, SB, ABS . . . ) , or
Nylons® (for example PA6, PA66, PA10, PA12 . . . ) , or
polyolephines (for example PE, PP),
Etc.

More generally, any polymer could be considered.

The first and second retention means should not be flexible, to allow a continuous retention of the tip within the head of the female part when the male and female parts are joined.

However, the first retention means could be slightly flexible in one direction, to allow the insertion of the tip of the male part into the head of the female part prior to the assembly of the male and female parts, and not flexible in the opposite direction, to prevent the removal of the tip of the male part from the head of the female part.

According to at least one embodiment, the second retention means protrude from an inner surface of the through-channel.

The second retention means thus forms a shoulder within the through-channel. For example, if the channel is substantially cylindrical, the second retention means protrude radially from an inner surface of the through-channel.

These retention means are therefore hidden within the through-channel, and cannot be damaged by a malicious person.

According to a first example, the second retention means are formed by an annular rib.

According to a second example, the second retention means are formed by a discontinuous rib.

For example, if the channel is substantially cylindrical, such discontinuous rib takes the form of a ½-annular rib, ⅔-annular rib, ¾-annular rib, or any other proportions.

For example, said discontinuous rib comprises at least two segments. In a specific embodiment, the discontinuous rib comprises at least one pair of identical segments.

According to at least one embodiment, the second retention means are formed by a narrowing of the through-channel.

For example, said narrowing of the through-channel has a frustoconical shape, whose largest diameter faced the first end of the through-channel.

In this way, the shape of the through-channel follows the shape of the tip of the male part. The tip is thus trapped within the head of the female part, and it is almost impossible to remove the male part from the female part without breaking it.

For example, said largest diameter is comprised between 6 to 10 mm.

According to at least one embodiment, the system also comprises a detachable auxiliary device, and the head of the female part comprises fastening means located at the second end of the through-channel,

the fastening means being configured to temporarily fasten the detachable auxiliary device to the head of the female part.

It is thus possible to add an accessory to the open head, using the fastening means to secure the accessory to the female part before and/or after the male part and the female part have been joined. Such accessory can be for example a sample container, a reflector, an insecticide tag, a monitoring device, an electronic ID, a temperature sensor, an additional identification tag, etc.

In this embodiment, the second retention means are located between the first retention means and the fastening means.

In particular, the male part cooperates with at least one cutting element intended to cut out a sample of animal tissue, and the detachable auxiliary device is a storage device for storing said sample.

A system according to the disclosure thus allows the detachable storage device to be temporarily attached to the fastening means of the head of the female part. In this manner, a sample can be collected when the tag is applied to the animal. The tasks performed by a user to both apply a tag and collect a sample are thus simplified, as they can be performed in a single action.

The disclosure thus proposes in at least one embodiment a one-shot and tamperproof tissue sampling tag (i.e. application of the tag, sampling and sealing the storage device in one action).

According to at least one embodiment, the fastening means comprise a helical rib provided on the internal surface of said through-channel.

The storage means can be provided with a complementary helical groove to allow quick and/or easy removal of the storage means after a sample has been collected.

If a helical rib is provided on the internal surface of the through channel, a first part of the helical rib can form the second retention means, and a second part of the helical rib can form the fastening means.

Alternatively, the fastening means comprise by a helical groove provided on the internal surface of said through-channel.

The storage means can be provided with a complementary helical rib to allow quick and/or easy removal of the storage means after a sample has been collected.

The disclosure also relates to a method for assembling a male part and a female part of a system for identifying an animal comprising:
pushing the tip of the male part into the through-channel through the first retention means of the head of the female part, to prevent removal of the tip through the first end of the through-channel, and
pushing the tip of the male part further into the through-channel until the tip of the male part is located between the first and the second retention means.

As already mentioned, the tip of the male part is thus trapped within the through-channel of the head of the female part, and cannot be removed even if the stem of the male part is cut or broken. Neither the female part, nor the male part can thus be re-used after the male and female parts have been fitted together. Indeed, the tip of the male part cannot be pulled out of the female part thanks to the first retention means. The tip of the male part cannot be pushed out of the female part thanks to the second retention means. If the male and female parts remain joined, they cannot be applied to another animal. If the stem of the male part is broken, the female part is not re-usable since its cavity is already filled with the tip of the male part. In addition, the male part is not re-usable since it does not have any tip and can therefore no longer be attached to another female part.

The disclosure also relates to a corresponding female part.

### 4. LIST OF FIGURES

Other features and advantages of the disclosure shall appear more clearly from the following description of particular embodiments, given by way of a simple illustratory and non-exhaustive examples and from the appended figures, of which:

FIG. 1 illustrates exemplary features of a system for identifying an animal according to the disclosure,

FIG. 2 illustrates exemplary steps of a method for assembling/joining a male part and a female part of the system of FIG. 1, and for taking a sample,

FIGS. 3A to 3C illustrate a first embodiment of a system for identifying an animal,

FIGS. 4A to 4D illustrate a second embodiment of a system for identifying an animal,

FIGS. 5A to 5D illustrate a third embodiment of a system for identifying an animal,

FIGS. 6A to 6D illustrate a fourth embodiment of a system for identifying an animal.

### 5. DETAILED DESCRIPTION OF EMBODIMENTS OF THE DISCLOSURE

5.1 General Principle The general principle of the disclosure relates to a system for identifying an animal that can be used to apply a tag to an animal. According to the disclosure, the female part of the tag has an open head before and after the male and female parts are joined. In certain embodiments, the open head comprises first retention means located at a first end of the through-channel of the female part and second retention means located within the through-channel, such that a tip of the male part is locked within the open head of the female part after the male and female parts have been fitted together. The male part cannot be removed from the female part without damaging the male and/or female part after the two parts have been joined. Such tag is thus tamper-proof, i.e. fraud-resistant.

In some embodiments, the open head also comprises fastening means located at the second end of the through-channel. Such fastening means can be used to provisionally and/or reversibly attach an auxiliary device or accessory to the head of the female part, such as a reflector, an insecticide tag, a monitoring device, an electronic ID, a temperature sensor, a storage device, an additional identification tag, etc.

In the following, we describe a system for identifying an animal that can be used to apply a tag to an animal and collect a sample of tissues of the animal in one-shot. The open head thus comprises fastening means configured to temporarily and/or reversibly fasten a detachable storage device to the head of the female part. In other embodiments, various accessories can be attached to the open head thanks to the fastening means. In other embodiments, no fastening means are provided on the open head.

FIG. 1 illustrates exemplary features of a system for identifying an animal according to an embodiment of the disclosure, comprising a male part 11, a female part 12, and an auxiliary device, for example a sample container, 13.

The male part 11 is provided with a male pin, or shaft, or stem 111 that extends from a base 110. The base 110 can take the form of a disk, a square, a rectangle, a label, etc, and can serve as a support for marking an identifier of the animal. The male part is also provided with a tip 112 at the end of the stem 111. Such tip can have a conical shape or a frustro-conical shape. Eventually, the stem 111 comprises a frangible portion or portion with reduced thickness. In the embodiment illustrated in FIG. 1, a cutting element 113, also called a punch, is temporarily fixed to the end of the truncated tip 112 and has a cutting edge enabling the animal's tissues to be cut out. According to another embodiment, the cutting element can take the form of a biopsy needle which slides within the male stem and tip. According to still another embodiment, the tip has a conical shape and does not cooperate with a cutting element.

The female part 12 comprises a head 121 defining a cavity for receiving the male tip, that extends from a base 120. The base 120 can take the form of a disk, a square, a rectangle, a label, etc, and can serve as a support for marking an identifier of the animal. The head 121 is a permanent open-head having a through-channel, i.e. a channel open from one end to the other end.

The head 121 comprises first retention means 1211 located at a first end of the through-channel, configured to prevent removal of the tip 112 of the male part through the first end of the through-channel after the male and female parts have been joined. The first end of the through-channel is the one through which the male tip can be inserted to apply the tag to the animal, i.e. the one located on the male tag side. For example, the first retention means 1211 comprise a washer having at least one leaf spring or claw. Such washer can be over-molded inside the head of the female part or assembled with the head of the female part. More generally, any element that allows the tip of the male part to be inserted into the female part through the first end of the through channel, but prevents its removal, can be used.

In some embodiments, the head 121 also comprises fastening means 1213 located at a second end of the through-channel, configured to temporary fasten the auxiliary device, for example the sample container 13, to the head 121 of the female part. The second end of the through-channel is the one through which the sample can be extracted, i.e. the one located at the sample container side.

As already mentioned, the temporary placement of the storage device 13 on the female head 121 allows a tag to be applied, and a sample to be collected and inserted into the storage device in a single action for the user. The number of actions to be performed by the user is thus reduced.

For example, the fastening means 1213 comprise a groove cooperating with a collar of the storage device 13, a helical groove (resp. rib) cooperating with a corresponding helical rib (resp. groove) of the storage device 13, etc. The storage device 13 can also be held by the fastening means 1213 in a snap or force fit arrangement. More generally, any element that allows the storage device 13 to be temporarily and/or reversibly fixed to the female part 12 can be used.

In addition, the head 121 comprises second retention means 1212, located within the through-channel, between the first retention means 1211 and the fastening means 1213, configured to prevent removal of the tip 112 of the male part through the second end of the through-channel after the male and female parts have been joined. For example, the second retention means 1212 take the form of a protrusion within the through-channel. Such protrusion is for example a substantially annular rib, which can be continuous or discontinuous. The second retention means 1212 can also take the form of a narrowing of the through channel. More generally, any element that prevents the removal of the tip of the male part form the female part, through the second end of the through-channel, can be used.

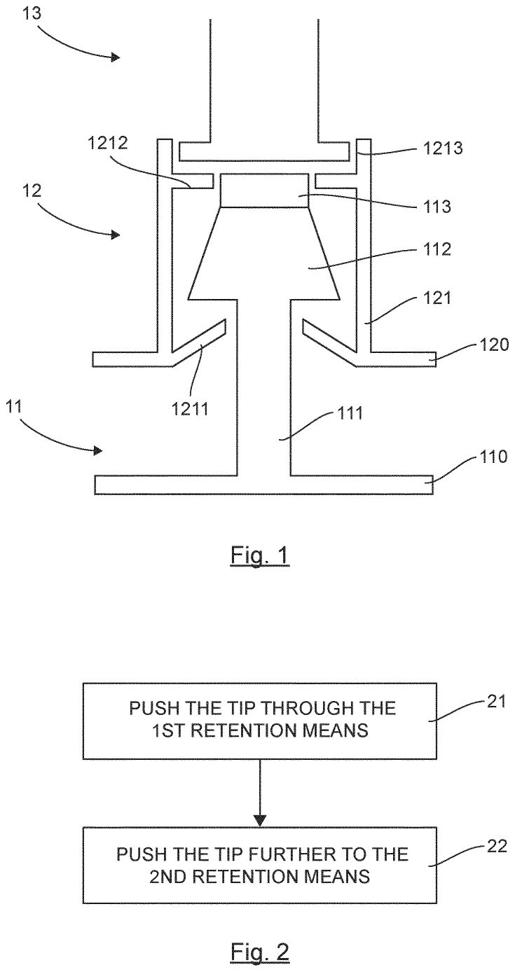

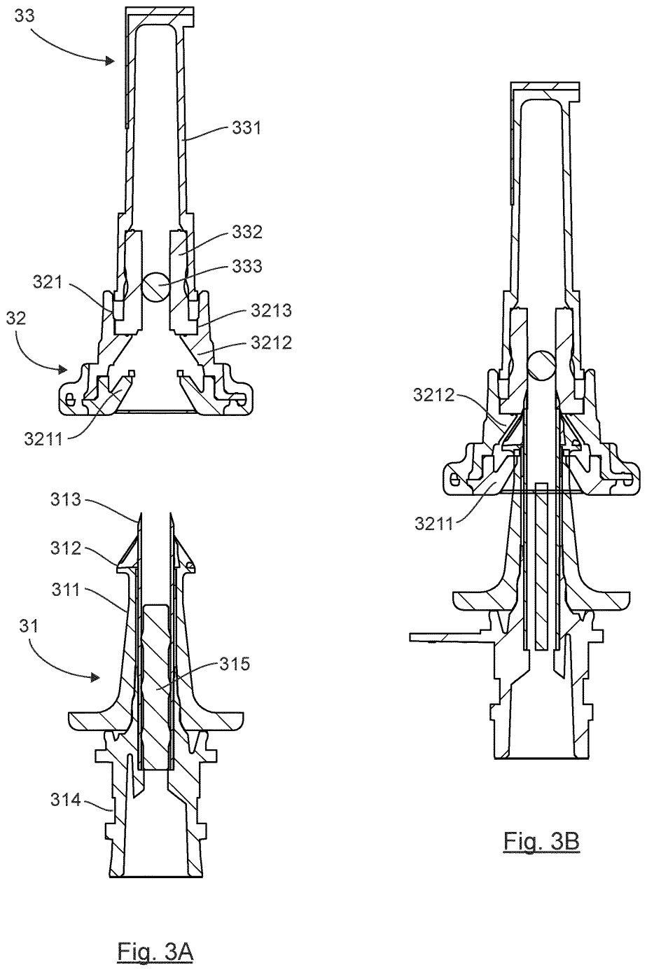

FIG. 2 illustrates the main steps of a method for assembling/joining a male part and a female part of the system of FIG. 1, and for taking a sample.

In an initial state, the cutting element is fixed to the end of the truncated tip 112 of the male part 11. The cutting element 113 can thus come into contact with for example the animal's ear.

In a first step 21, the tip 112 with the cutting element 113 is pushed through the animal's ear and enter into the cavity of the female part 12, through the first retention means 1211 of the head 121 of the female part.

Once the base of the tip 112 has passed through the first retention means 1211, the tip 112 cannot be removed without damaging the first retention means 1211. For example, if the first retention means 1211 comprise at least one finger or projection, such fingers can move or flex as the tip 112 is force through the first end of the through channel, into the cavity of the female part. Once the tip 112 is located within the cavity, the fingers can become restored to their normal state, and engage behind the base/shoulder of the tip 112. The tip 112 cannot be pulled back out of the cavity through the first end of the through channel.

In a second step 22, the tip 112 is pushed further into the through-channel, until the cutting element 113 is housed in the storage device 13. The storage device 13 closed by the cutting element 113 is then detached from the female part 12. The tip 112 is however retained within the cavity by the second retention means 1222. The tip 112 thus remains located between the first and the second retention means. The tip 112 cannot be pushed back out of the cavity through the second end of the through channel.

As a consequence, if the stem 111 of the male part is cut or breaks (for example, the frangible portion of the stem can be broken if there is an attempt to remove the tag), the tip 112 remains within the cavity of the female part. Neither the male part 12, nor the female part 11 can thus be reused, which ensures the inviolability or tamper-proofness of the system.

In addition, the head of the female part 11 is open before a sample is taken, which enables the simultaneous application of a tag and collection of samples, by temporarily fixing a storage device to the second end of the through channel. The head of the female part 11 remains open after a sample has been taken, which enables for example to fix another accessory to the female part, such as a reflector, an insecticide tag, a monitoring device, an electronic ID, a temperature sensor, another storage device, etc.

The disclosure thus proposes a one-shot tamperproof tissue sampling tag: in a single action (for example an actuation of an ear tag applicator), a tag is thus applied on an animal, a tissue sample is collected and inserted in a storage device, and the storage device is closed.

Several embodiments are now described in more details.

### 5.2 First Embodiment

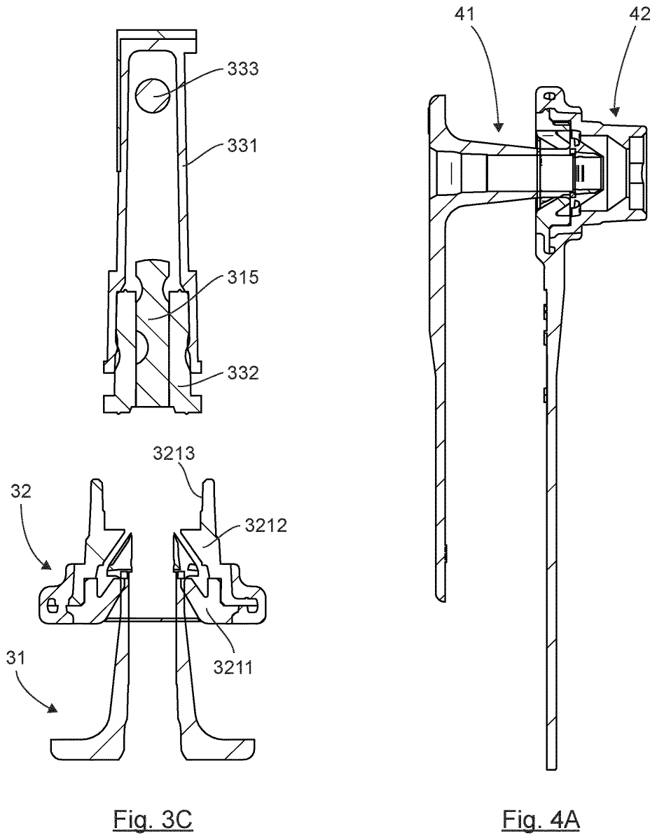

FIGS. 3A to 3C illustrate a system for identifying an animal according to a first embodiment. In an initial stage illustrated in FIG. 3A, i.e. before assembly, the male part 31 and female part 32 are disjoined. The stem 311 of the male part 31 can be hollow, and a cutting element, for example a needle 313, can slide within the stem 311. The end of the needle can protrude from the tip 312 of the male part, to be able to cut out a sample of tissue from the animal. The needle 313 can be supported by a support 314, made for example of hard plastic. Such support can be temporarily fixed to an applicator used to apply the tag. An extractor or pusher element 315 can be provided within the needle 313. Such extractor can slide within the needle, to push the sample out of the needle 313 and close the storage device, as shown on FIG. 3C. The use of a pusher element is described for example in patent application WO2010/066475 and is not described here in further detail. Naturally, the use of such a pusher element is optional and corresponds solely to a particular embodiment of the invention. Alternatively, a punch can be temporarily fixed at the end of the tip 312, and can be used to cut a sample of tissue, to push it within the storage device, and to close the storage device.

Back to the initial stage illustrated in FIG. 3A, the female part 32 comprises a rigid open head 321. As per the first and/or second retention means, the open head should be made of a hard material. For example, it can be made of acrylonitrile butadiene styrene, or polyamide, or styrene (for example PS, SB, ABS . . . ), or Nylons® (for example PA6, PA66, PA10, PA12 . . . ), or polyolephines (for example PE, PP), etc. More generally, any polymer could be considered.

The open head 321 comprises first retention means 3211 located at a first end of the through channel, fastening means 3213 located at a second end of the through-channel, and second retention means 3212 located within the through-channel, between the first retention means 3211 and the fastening means 3213. The first retention means 3211 comprise, for example, a washer having at least one leaf spring or claw. Such washer can be over-molded inside the head of the female part or assembled with the head of the female part. More generally, the first retention means 3211 may be any element that allows the tip of the male part to be inserted into the female part through the first end of the through channel, but prevents its removal, as illustrated in FIG. 3C. The second retention means 3212 are formed by a narrowing of the through-channel, for example with a frustoconical shape whose largest diameter faced the first end of the through-channel. The second retention means 3212 thus allow the retention of the tip within the head of the female part when the male and female parts are joined, as illustrated in FIG. 3C.

It can be noted that the thickness of the wall of the open head can be comprised between 0.5 and 3 mm, for example between 1 and 1.5 mm. The outer part of the open head can remain substantially cylindrical.

The storage device 33 is temporarily and/or removably fixed to the open head 321 thanks to the fastening means 3213. For example, such device can be screwed into the through-channel of the female part, force-fitted into the female part, clipped to the female part, etc.

For example, the storage device 33 comprises a tube 331 intended to receive the sample, provided with a tube head 332 and a weighted element 333, for example a bead or a ball.

According to this example, the tube head 332 is fixedly attached to the inlet of the tube 331, for example by being clipped on, fitted in, etc. It can be made flexibly, especially out of rubber, to facilitate its insertion into the neck of the tube. More specifically, the tube head 332 takes the form of a hood pierced with a central aperture, having a diameter sufficient to enable the insertion of the ball 333. The tube head 332 also has a flange. The use of such a flange makes it possible to facilitate the positioning and removal of the hood. In an embodiment, the flange can define a stop surface on which the cutting edge of a cutting element (for example the needle 313) can take support in order to cut out the tissue sample more easily. Such flange can be pressed against the inner wall of the through-channel or inserted in a groove of the through-channel to temporarily fix the storage device 33 to the female part 32.

In an operational stage illustrated in FIG. 3B, i.e. during assembly of the male and female part and sample collection, the male part 31 is inserted within the head 321, through the first end of the through-channel. The male part 31, with the protruding needle 313, can be pushed inside the through-channel until the tip 312 abuts the second retention means and/or the cutting edge of the needle abuts the flange of the tube head 332 and/or the needle is partially inserted within the storage device 33 for example. The pusher element 315 can then push the tissue sample out of the needle 313, push the ball 333 and close the tube head 332.

In a final stage illustrated in FIG. 3C, i.e. after assembly of the male part 31 and the female part 32, the storage device 33 comprising the tissue sample can be detached from the female part 32. The tube head 332 can be closed by the pusher element 315.

The tip 312 of the male part is trapped between the first retention means 3211 and the second retention means 3212, and cannot be removed. Even if the stem 311 of the male part is cut or broken, the tip 312 cannot be withdrawn from the open head 321. In this first embodiment, the conical or frustro-conical shape of the through channel in the open head of the female part thus allow to obtain a tamperproof tag. As previously described, the open head also allows to push out a movable component to close the storage device after sampling.

The needle 313 can be pulled out of the stem 311 and discarded.

### 5.3 Second Embodiment

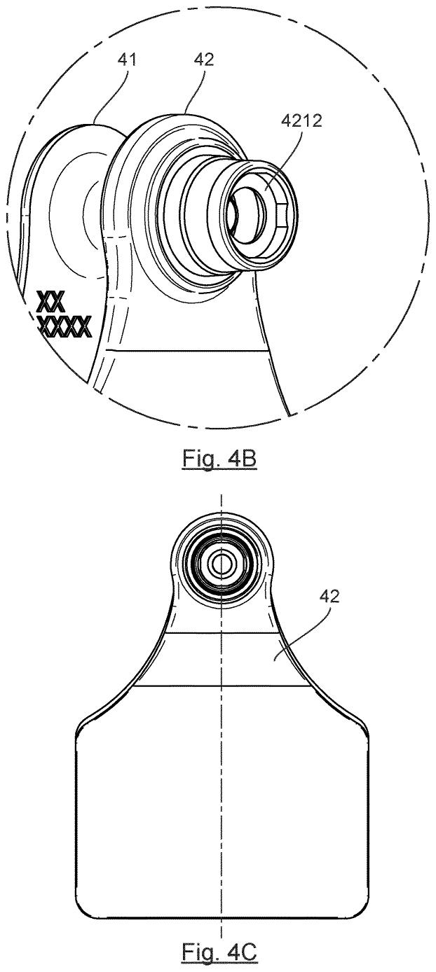

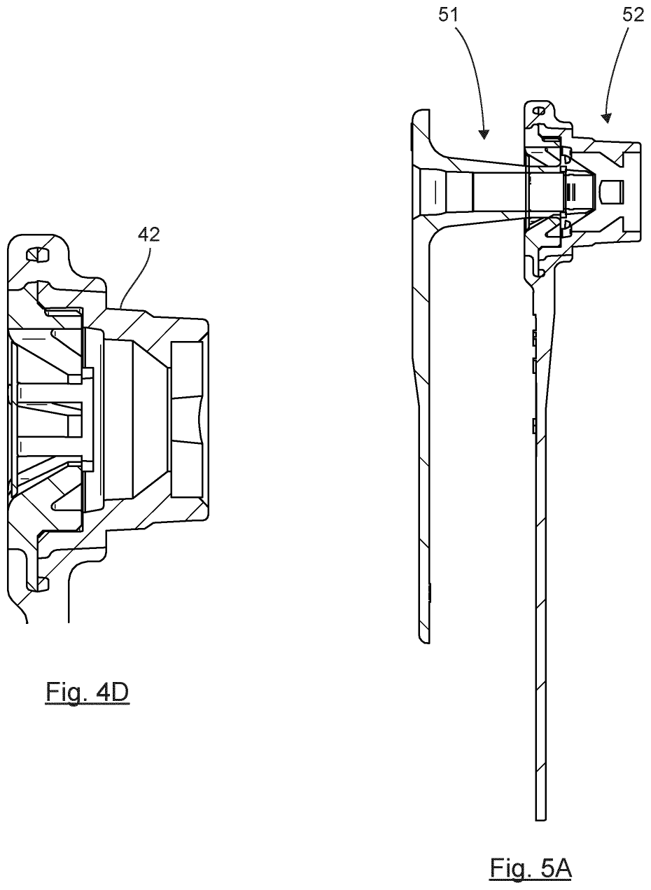

FIGS. 4A to 4C illustrate a second embodiment, after assembly of the male part 41 and the female part 42. FIG. 4D zooms in on the female part 42 before assembly with the male part 41.

In this second embodiment, the second retention means comprise a continuous annular rib 4212. The through-channel can be substantial cylindrical, or can comprise a first portion which is substantially cylindrical and a second portion which is substantially frustro-conical.

For example, the largest diameter of the tip of the male part 41 is comprised between 6 and 10 mm. The diameter of the hole defined by the annular rib 4212 or by the smallest diameter of the through-channel should be smaller than the largest diameter of the tip of the male part 41, for example comprised between 3 and 7 mm. The diameter of the hole defined by the annular rib 4212 or by the smallest diameter of the through-channel should be large enough to allow a cutting element or a pusher element or any movable element to close the storage device after sampling. The open head diameter is for example comprised between 10 and 14 mm.

In the example illustrated in FIGS. 4A to 4D, the removable storage device can be force-fitted into the second end of the through-channel of the female part or clipped to the second end of the through-channel.

### 5.4 Third Embodiment

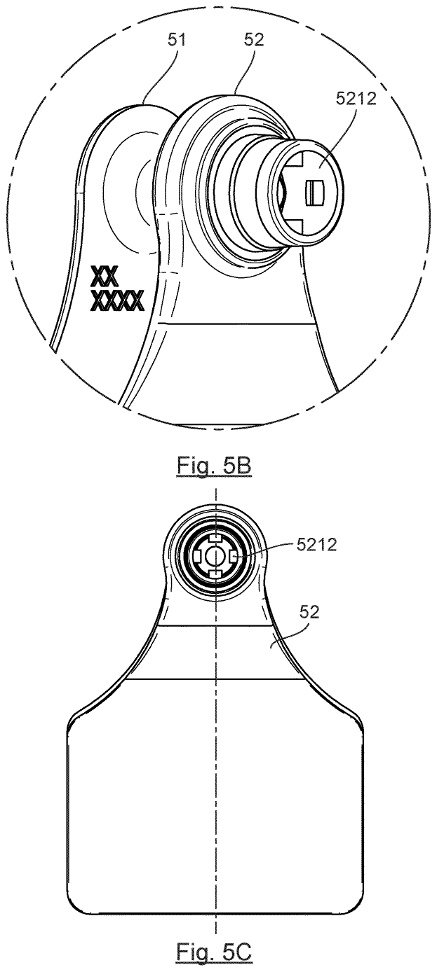

FIGS. 5A to 5C illustrate a third embodiment, after assembly of the male part 51 and the female part 52. FIG. 5D zooms in on the female part 52 before assembly with the male part 51.

In this third embodiment, the second retention means comprise at least one toe or rib 5212. For example, said at least one toe or rib 5212 can protrude on the same cross-sectional plane of the through-channel axis. In a first example, a rib can be a portion of a discontinuous annular rib. In another example, the use of several ribs protruding on the same cross-sectional plane helps to center the cutting element when the sample is collected, and to maintain the tip within the open head even if the stem of the male part is cut or broken. For example, the second retention means comprise at least one pair of ribs having a same length. The through-channel can be substantial cylindrical, or can comprise a first portion which is substantially cylindrical and a second portion which is substantially furstro-conical.

In the example illustrated in FIGS. 5A to 5D, the second retention means comprise four ribs.

Once again, the diameter of the hole defined by the four ribs 5212, or by the smallest diameter of the through-channel, should be smaller than the largest diameter of the tip of the male part 51, for example comprised between 3 and 7 mm. As for the other embodiments, the diameter of the hole defined by the ribs 5212, or by the smallest diameter of the through-channel, should be large enough to allow a cutting element or a pusher element or any movable element to close the storage device after sampling.

In the example illustrated in FIGS. 5A to 5D, the removable storage device can be force-fitted into the second end of the through-channel of the female part or clipped to the second end of the through-channel.

### 5.5 Fourth Embodiment

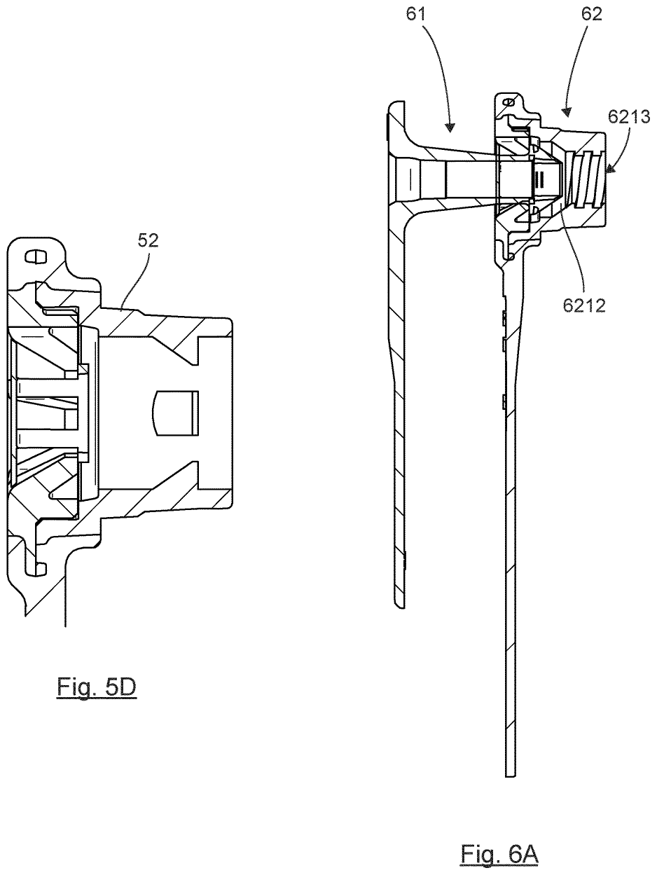

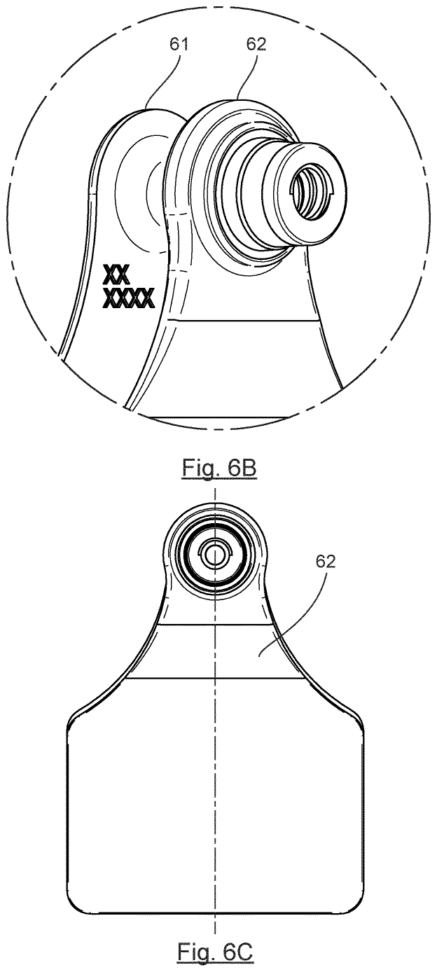

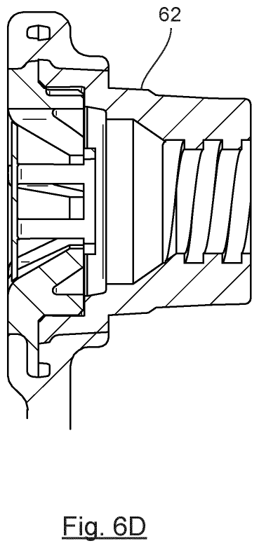

FIGS. 6A to 6C illustrate a fourth embodiment, after assembly of the male part 61 and the female part 62. FIG. 6D zooms in on the female part 52 before assembly with the male part 51.

In this fourth embodiment, the second retention means comprise a first part 6212 of a helical rib. The through-channel can be substantial cylindrical, or can comprise a first portion which is substantially cylindrical and a second portion which is substantially furstro-conical.

A second part 6213 of the helical rib can form the fastening means.

Once again, the diameter of the hole defined by the helical rib, or by the smallest diameter of the through-channel, should be smaller than the largest diameter of the tip of the male part 61, for example comprised between 3 and 7 mm. As for the other embodiments, the diameter of the hole defined by the helical rib, or by the smallest diameter of the through-channel, should be large enough to allow a cutting element or a pusher element or any movable element to close the storage device after sampling.

In the example illustrated in FIGS. 6A to 6D, the removable storage device can be screwed into the second end of the through-channel of the female part before assembling the male and female parts. After removal of the storage device from the female part, another accessory can be screwed into the second end of the through channel.

### 5.6 Variants

The illustrator examples given above can be combined. For example, the fastening means of the helical rib type of FIGS. 6A to 6D can be used with the second retention means of FIG. 4A to 4D or 5A to 5D.

In addition, the distance between the first and second retention means can vary. For example, the distance between the first retention means and the second retention means (for example between the end of the fingers of the first retention means and the rib of the second retention means) can be substantially equal to the height of the tip of the male part. For example, the height of the tip of the male part is comprised between 3 and 5 mm, and the distance between the first retention means and the second retention means is comprised between 3.5 and 5.5 mm. In this way, the tip of the male part is held tightly within the female part. The shape of the through-channel can thus follow the shape of the tip of the male part, and the inviolability of the tag is reinforced. In another embodiment, the distance between the first retention means and the second retention means can be greater than the height of the tip of the male part. For example, the height of the tip of the male part is comprised between 3 and 5 mm, and the distance between the first retention means and the second retention means is comprised between 6 and 9 mm. In this way, the tip of the male part can move inside the female part, for example along the axis of the stem of the male part, which can help an animal to free itself if its tag is stuck in a fence for example.

1. A system for identifying an animal comprising:
a male part,
a female part with an open head having a through-channel,
wherein the open head of the female part comprises first retention means located at a first end of the through-channel,
the first retention means being configured to prevent removal of a tip of the male part through the first end of the through-channel after the male and female parts have been joined,
and wherein the open head of the female part also comprises second retention means, located within the through-channel,
said second retention means being configured to prevent removal of the tip of the male part through the second end of the through-channel after the male and female parts have been joined.

2. The system according to claim 1, wherein said second retention means protrude from an inner surface of the through-channel.

3. The system according to claim 2, wherein said second retention means are formed by an annular rib.

4. The system according to claim 2, wherein said second retention means are formed by a discontinuous rib.

5. The system according to claim 4, wherein said discontinuous rib comprises at least two segments.

6. The system according to claim 4, wherein said discontinuous rib comprises at least one pair of identical segments.

7. The system according to claim 1, wherein said second retention means are formed by a narrowing of the through-channel.

8. The system according to claim 7, wherein said narrowing of the through-channel has a frustoconical shape, whose largest diameter faced the first end of the through-channel.

9. The system according to claim 8, wherein said largest diameter is between 6 to 10 mm.

10. The system according to claim 1, wherein at least one of said first and second retention means is made of:
acrylonitrile butadiene styrene, or
polyamide, or
styrene, or
Nylons®, or
polyolephines.

11. The system according to claim 1, wherein the system also comprises a detachable auxiliary device, and wherein the head of the female part comprises fastening means located at the second end of the through-channel,
the fastening means being configured to temporarily fasten the detachable auxiliary device to the head of the female part.

12. The system according to claim 11, wherein the male part cooperates with at least one cutting element intended to cut out a sample of animal tissue, and wherein the detachable auxiliary device is a storage device for storing said sample.

13. The system according to claim 11, wherein said fastening means are provided by a helical rib or groove provided on the internal surface of said through-channel.

14. A method for assembling a male part and a female part of a system for identifying an animal according to claim 1, wherein the method comprises:
pushing the tip of the male part into the through-channel through the first retention means of the head of the female part, to prevent removal of the tip through the first end of the through-channel, and
pushing the tip of the male part further into the through-channel until the tip of the male part is located between the first and the second retention means.

15. A female part of a system for identifying an animal, said female part comprising an open head, with a through-channel, intended to cooperate with a male part,
wherein the open head of the female part comprises first retention means located at a first end of the through-channel,
the first retention means being intended to prevent removal of a tip of the male part through the first end of the through-channel after the male and female parts have been joined, and wherein the open head of the female part also comprises second retention means, located within the through-channel,
said second retention means being intended to prevent removal of the tip of the male part through the second end of the through-channel after the male and female parts have been joined.
